(19) United States
(12) Patent Application Publication
(10) Pub. No.: US 2003/0228436 A1
(43) Pub. Date: Dec. 11, 2003

(54) Peel-off sticker for health care

(76) Inventor: Kazunari Ishimura, Kumamoto-city (JP)

Correspondence Address: ISRAEL GOPSTEIN, 14301 Layhill Rd., Suite 200C, P.O. Box 9303, Silver Spring, MD, 20916-9303, US

(21) Appl. No.: 10/163,876

(22) Filed: Jun. 7, 2002

(51) Int. Cl. B32B 9/00

(52) U.S. Cl. 428/42.3; 428/40.1

(57) ABSTRACT

A peel-off sticker for health care is not only effective to alleviate or cure the affected area of a part of the human body, for example the stiffness in shoulders or back pain, but also effective to exert health-care effects such as weight-loss effect and the reduction in percent of body fat by accelerating the activities of internal organs of the human body. The peel-off sticker for health care has a medical tape made of a natural material such as a natural stretch fabric of cotton; and an adhesive layer including a far-infrared radiation material applied on the surface of the medical tape. At least one cutoff line is formed in the medical tape such that a concentric magnetic field is generated in use.

### BACKGROUND OF THE INVENTION

1. Field of the Invention

The present invention relates to a peel-off sticker for health care.

2. Description of the Prior Art

Heretofore, peel-off stickers for health care (hereinafter, also referred to as heath care patches) have been known in the art. As shown in FIG. 8, typically, the health care patch (A) comprises a medical tape (a) made of a natural material such as a natural stretch fabric of cotton, an adhesive layer (b) applied on the surface of the medical tape (a), and magnetic particles (c) adhered on the adhesive layer (b).

The health care patch (A) thus constructed is put on the affected area of a human body or a pressure point that corresponds to such an affected area by the adhesion of the adhesive layer b. Thus, the magnetic particles (c) adhered on the adhesive layer (b) may accelerate the bloodstream in the affected area of the human body to alleviate or cure the stiffness in shoulders, back pain, or the like.

However, the above health care patch (A) described above is only provided as a single patch having a predetermined diameter. Therefore, it cannot be applied effectively or economically on various kinds of affected areas or pressure points having different dimensions or different numbers.

In addition, each of the magnetic particles (c) being embedded in the adhesive layer (b) has a comparatively large diameter such that it is protruded from the health care patch (A). During the usage, the touch of such a protruded provides the user with an uncomfortable feeling. Furthermore, the magnetic field exerted from the patch (A) effects only on a restricted narrow portion of the affected area of the body. Therefore, the effects of the health care patch (A) may be restricted to alleviate or cure the stiffness in shoulders, back pain, or the like. In other words, the health care patch (A) is hardly exert health-care effects such as weight-loss effect and the reduction in percent of body fat by accelerating the activities of internal organs of the human body and improving user's physical condition (e.g., altering the body's chemistry to the so-called minus ion state).

### SUMMARY OF THE INVENTION

Therefore, the present invention has been completed in consideration of the above problems. It is an object of the present invention is to provide a peel-off sticker not only effective to alleviate or cure the affected area of a human body, for example the stiffness in shoulders or back pain, but also effective to exert health-care effects such as weight-loss effect and the reduction in percent of body fat by accelerating the activities of internal organs of the human body.

For attaining the above object, a first aspect of the present invention is to provide a peel-off sticker for health care, comprising: a medical tape made of a natural material such as a natural stretch fabric of cotton; and an adhesive layer including a far-infrared radiation material applied on the surface of the medical tape, wherein at least one cutoff line is formed in the medical tape such that a concentric magnetic field is generated in use.

A second aspect of the present invention is to provide: a peel-off sticker for health care, comprising: a plurality of peel-off stickers, where each of the peel-off stickers has a medical tape made of a natural material such as a natural stretch fabric of cotton and an adhesive layer including a far-infrared radiation material applied on the surface of the medical tape; and a board on which the plurality of the peel-off stickers are removably adhered by means of the adhesive layer, wherein at least one concentric cutoff line is formed in the medical tape such that each of the peel-off stickers generates a concentric magnetic field in use.

Here, each of the peel-off stickers may have its own dimensions and its own number of the cutoff lines and is removably adhered on the board by means of the adhesive layer.

Furthermore, the far-infrared radiation material may be one of ceramic, tourmaline, and bamboo charcoal fine powders.

### BRIEF DESCRIPTION OF THE DRAWINGS

FIG. 1(A) is a schematic view of a peel-off sticker for health care as one of preferred embodiments of the present invention, and FIG. 1(B) is a schematic diagram of the peel-off sticker, where the peel-off sticker is divided into three pieces;

FIG. 2 is an enlarged cross sectional view of the peel-off sticker for health care;

FIG. 3 is a front view of a plurality of the peel-off stickers being adhered on the board in accordance with one of preferred embodiments of the present invention;

FIG. 4 is a front view of a plurality of the peel-off stickers being adhered on the board in accordance with another preferred embodiment of the present invention;

FIG. 5 is a cross sectional view along the line A-A in FIG. 3;

FIG. 6 is a cross sectional view along the line B-B in FIG. 4;

FIG. 7 is a pictorial view for illustrating the peel-off sticker in use; and

FIG. 8 is a plan view of the conventional peel-off sticker.

### DETAILED DESCRIPTION OF THE PREFERRED EMBODIMENTS

Hereinafter, we will describe a peel-off sticker for health care as one of preferred embodiments of the invention with reference to the attached drawings.

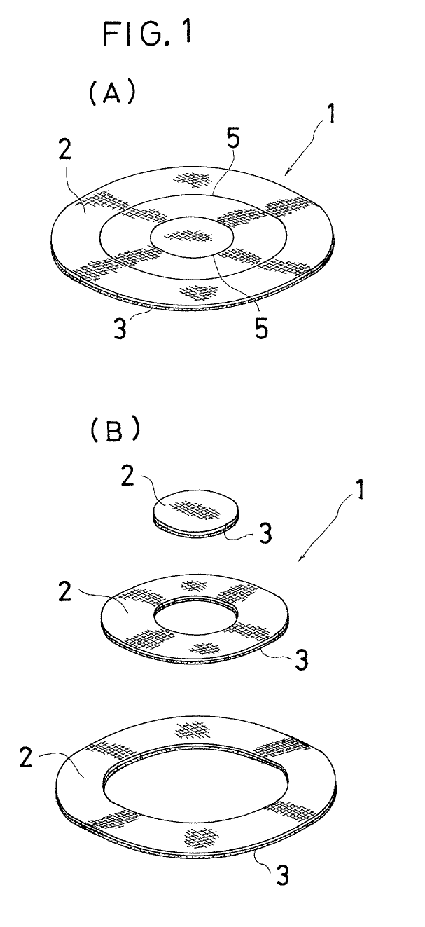

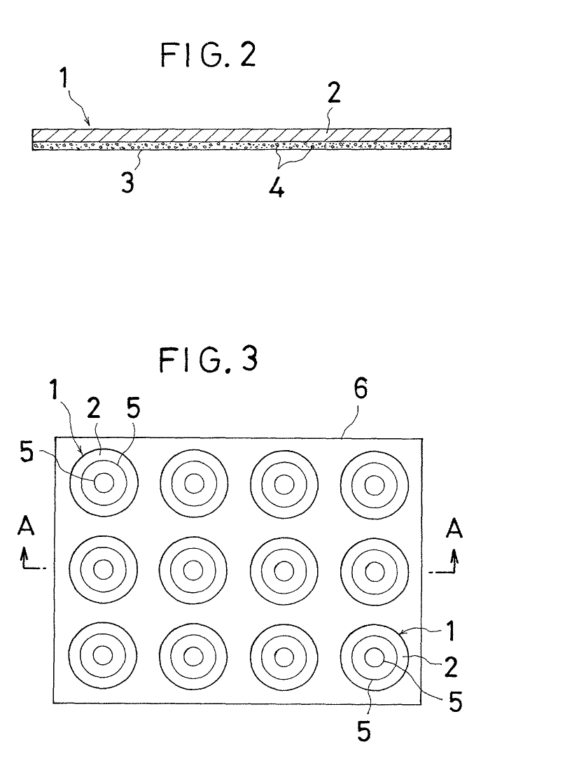

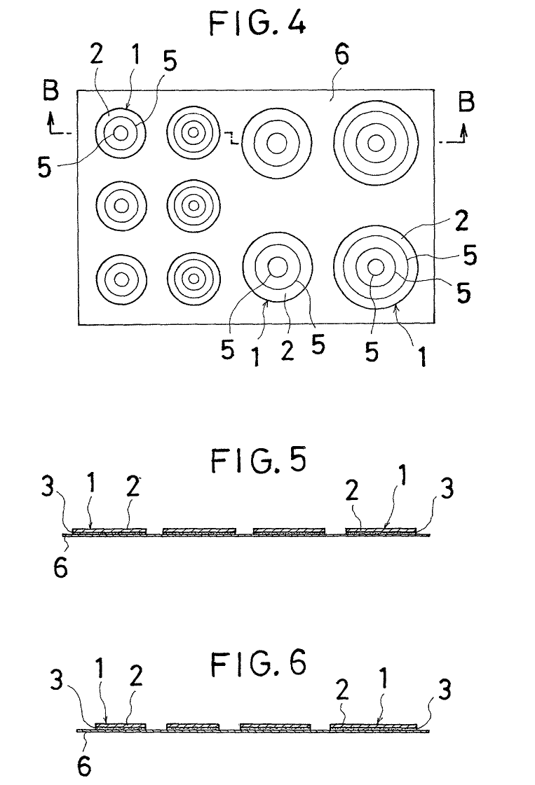

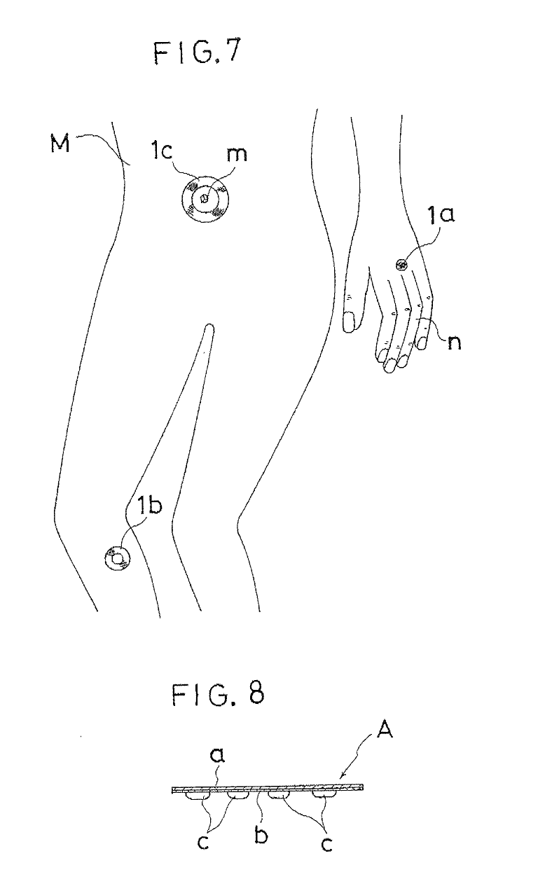

FIG. 1(A) is a schematic view of a peel-off sticker for health care as one of preferred embodiments of the present invention. FIG. 1(B) is a schematic diagram of the peel-off sticker, where the peel-off sticker is divided into three pieces of sticker fragments along the respective cutoff lines. FIG. 2 is an enlarged cross sectional view of the peel-off sticker shown in FIG. 1. FIG. 3 is a front view of a plurality of the peel-off stickers being adhered on the board. Also, FIG. 4 is a front view of a plurality of the peel-off stickers being adhered on the board as another preferred embodiment of the present invention. FIG. 5 is a cross sectional view along the line A-A in FIG. 3, while FIG. 6 is a cross sectional view along the line B-B in FIG. 4. Furthermore, FIG. 7 is a pictorial view for illustrating the peel-off sticker in use.

As shown in FIG. 1(A), FIG. 1(B), and FIG. 2, the peel-off sticker 1 of the present embodiment comprises: a medical tape 2 which is shaped like a circular flat plate and is made of a natural material such as a natural stretch fabric of cotton; and an adhesive layer 3 including a far-infrared radiation material 4 applied on one side of the medical tape. Also, at least one cutoff line is formed in the medical tape 2. In this embodiment, as shown in FIG. 1(A), there are two cutoff lines concentrically formed in the surface of the medical tape 2. Also, the depth of the cutoff line extends from the surface of the medical tape 2 to the adhesive layer 3 such that one concentric sticker fragment can be separated from the other piece thereof. Therefore, a concentric magnetic field can be generated from the concentric sticker fragment in use.

The above circular medical tape 2 may be a stretch natural material such as a knitted fabric of 100% cotton, which does not produce irritation to skin and allows a stable radiation of an electromagnetic wave to the target part of the body.

The far-infrared radiation material 4 included in the above adhesive layer 3 is being dissolved in a far-infrared radiation fluctuating water. The resulting aqueous solution is immersed in the composition of the adhesive layer 3. More concretely, any material that releases energies or waves effective to a human body, such as ceramic, tourmaline, or bamboo charcoal, and an adhesive component (e.g., silicon rubber) are mixed together to prepare a smooth viscous mixture (i.e., a paste). Subsequently, the resulting paste is coated as a thin film on the medical tape 2.

The concentric cutoff line 5 is formed in the circular medical tape 2 such that the depth thereof extends to the adhesive layer 3. Therefore, opposite ends of the respective cut surfaces of the cutoff line 5 in the medical tape 2 is weakly joined together by the adhesive material such that they can be easily separated from each other by pulling them in opposite directions by fingers.

In the present embodiment shown in the figure, there are two cutoff lines 5 formed in the medical tape 2, so that the peel-off sticker can be separated into three pieces of the sticker fragments: a small circular sticker fragment (patch with a diameter of 1 cm) 1a, a small ring-shaped sticker fragment (patch with a diameter of 5 cm) 1b, and a large ring-shaped sticker fragment (patch with a diameter of 5 cm) 1c. According to the present invention, however, the number of the cutoff lines 5 is not limited to two. One cutoff line or three or more cutoff lines may be allowed as the need arises. In addition, the number of sticker fragments depends on the number of cutoff lines.

Referring now to FIG. 4, there is shown another peel-off sticker 1 as another preferred embodiment of the present invention. In this case, a plurality of peel-off stickers 1 having different surface areas and different numbers of cutoff lines 5 are provided on a board 6. Therefore, it can be possible to apply the peel-off stickers to any affected portions of a human body having different surface areas and numbers.

As shown in FIG. 3 and FIG. 4, various kinds of the peel-off stickers 1 described above can be removably placed lengthwise and crosswise on the surface of the board 6 through the respective adhesive layers 3. Therefore, the required number and size of the peel-off stickers 1 can be removed from the board 6 and placed on the affected portion, the pressure point, or the like of a human body.

Hereinafter, we will describe a usage method of the peel-off sticker 1 for health care.

As shown in FIG. 7, for example, if it is used for slimming, the large-sized ring patch 1c is put on the body M through its adhesive layer 3 such that the ring-shaped patch 1c surrounds the navel m. In addition, the small-sized ring patch 1a is put on the base of an annular finger n, which is known as a slimming press point. Furthermore, another small-sized ring patch 1b may be put on another press point for slimming, such as “SANRI” (a technical term of oriental medicine; a slightly-hollowed portion outwardly under the patella) of a leg.

When the peel-off sticker 1 is being placed on the affected area or press point of the body, the far-infrared radiation material 4 such as ceramic, tourmaline, or bamboo charcoal fine powders exerts the minus ion's healing effect promptly on the skin being touched with such a material 4. That is, the electromagnetic energy released from the far-infrared radiation material 4 decomposes the whole body fluid such as blood and lymph and the water contained in cells into single water molecules. Therefore, each water molecule is allowed to release a free electron e- to make the body in a minus-ion dominant state, resulting in accelerating the activity of each organ in the body.

Furthermore, each peel-off sticker fragment is shaped like a ring, so that a concentric electric field can be generated. Therefore, strong balanced steady electromagnetic waves can be radiated effectively toward the body. The minus-ion dominant state obtained by putting the above large- or small-sized patch 1c, 1b appropriately reduces a SOD active enzyme that inhibits the generation of surplus active enzyme, accelerating the improvement of physical condition. Furthermore, the minus-ion dominant blood or body fluid exerts the effects of decomposing and eliminating the fatigue substances accumulated in the body, the waste products, and neutral fat.

The electromagnetic wave to be generated in the embodiment is mainly comprised of a far-infrared radiation raising electromagnetic wave having a wavelength of 10±4 ìm and releases a weak current of 0.06 mA.

The exemplified peel-off sticker of the present invention is constructed as described above, so that the following effects can be exerted.

1. When the peel-off sticker is put on the affected area or press point of the body, the effects of fluctuated electromagnetic waves facilitate the activities of weakly alkalinizing the blood in the body and eliminating the waste products from the body to put vitality into the body. As a result, the body's chemistry is lead in s state of minus-ion dominant.

2. The effects of fluctuated electromagnetic waves generated by the far-infrared radiation material activate the function of intestine, so that the improvement in constipation can be anticipated. In addition, the blood functions are activated, so that the improvement in the flow of urine and also the improvement in edema can be anticipated. Furthermore, the improvement in neurotransmission can be also anticipated. Moreover, as the body fluid its self is improved, so that the improvements in stiff neck and cold constitution can be anticipated.

3. When the ring-shaped peel-off sticker is put on a press point around the navel, the activities of organs can be facilitated to bring the body's chemistry into a state of minus-ion. As a result, the percent of body fat can be reduced and the decrease in body weight can be anticipated. More specifically, as the peel-off sticker is shaped into a ring, the concentric magnetic field is generated. As a result, strong balanced steady electromagnetic waves can be radiated effectively toward the body.

4. A desired peel-off sticker can be selected from the peel-off stickers having different sizes and different numbers of cutoff lines. Subsequently, it can be separated by cutting along the cutoff line. Therefore, the peel-off sticker can be used so as to be effectively and economically used depending on the size and number of the affected areas of the body or the press points corresponding to the affected areas.

5. The far-infrared radiation material contained in the adhesive layer is used as a powder, so that such a layer allows a smooth feeling without asperities when it is touched, while touching the conventional product causes a uncomfortable feeling.

What is claimed is:

1. A peel-off sticker for health cares, comprising: a medical tape made of a natural material; and
an adhesive layer including a far-infrared radiation material applied on the surface of the medical tape, wherein at least one cutoff line is formed in the medical tape such that a concentric magnetic field is generated in use.

2. A peel-off sticker for health cares, comprising:
a plurality of peel-off stickers, where each of the peel-off stickers has a medical tape made of a natural material and an adhesive layer including a far-infrared radiation material applied on the surface of the medical tape; and
a board on which the plurality of the peel-off stickers are removably adhered by means of the adhesive layer, wherein
at least one concentric cutoff line is formed in the medical tape such that each of the peel-off stickers generates a concentric magnetic field in use.

3. A peel-off sticker for health care as claimed in claim 2, wherein
each of the peel-off stickers has its own dimensions and its own number of the cutoff lines and is removably adhered on the board by means of the adhesive layer.

4. A peel-off sticker for health care as claimed in one of claims 1 to 3, wherein
the far-infrared radiation material is one selected from a group of ceramic, tourmaline, and bamboo charcoal fine powders.

5. A peel-off sticker for health care as claimed in claim 1 or claim 2, wherein
the natural material is a natural stretch fabric of cotton.
